(19) United States
(12) Patent Application Publication
(10) Pub. No.: US 2010/0023669 A1
(43) Pub. Date: Jan. 28, 2010

(54) HOST CONTROLLER DISPOSED IN MULTI-FUNCTION CARD READER

(76) Inventor: Lian-Chun Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/350,228

(22) Filed: Jan. 8, 2009

(30) Foreign Application Priority Data
Jul. 24, 2008 (TW) 097128116

(51) Int. Cl. G06F 13/00

(52) U.S. Cl. 710/301

(57) ABSTRACT

A host controller disposed in a multi-function card reader includes: a Serial Advanced Technology Attachment (SATA) interface configured for coupling to a host computer; and a port multiplier having a control port and a plurality of peripheral device ports. The control port is coupled to the SATA interface, and the peripheral device ports are coupled to a plurality of peripheral device interfaces, respectively. The peripheral device interfaces are disposed in the multi-function card reader, and include at least one flash memory card interface.

### BACKGROUND OF THE INVENTION

1. Field of the Invention

The present invention relates to a controller, and more particularly to a host controller disposed in a multi-function card reader based on a Serial Advanced Technology Attachment (SATA) interface in order to control several peripheral devices (e.g. memory cards).

2. Description of the Prior Art

For many years, data storage devices have been an indispensable part of computer systems. Owing to different functions, the kinds of data storage devices available are numerous, such as: floppy disk drives, hard disk drives, optical disk drives, and flash memories. These data storage devices are further developed along two lines: capable of storing more data, and decreased device size. As the sizes of these data storage devices are continually reduced, they appear in a variety of portable data storage devices, such as flash memory cards and external hard disk drives. Due to convenience of usage and the fact that data storage devices usually need to be coupled to a computer system, there are many external interface apparatus employed by the computer system in order to connect these data storage devices, making the computer system access to these data storage devices quick and easy.

Usually, these external interface devices support several data storage devices of different kinds of interfaces. Flash memory cards can be used with most external access device due to a variety of specialized standards. An external access device for supporting several kinds of flash memory cards is usually called a memory card reader. Generally, most memory card readers connect to computer systems via a Universal serial Bus (USB), which has a smaller pin count and is also capable of plug-and-play. Thus, these external access devices are usually capable of supporting more than one standard and are designed outside a host computer for convenience of connection. There are also some memory card readers based on a PCI (Peripheral Component Interconnect) bus or a PCI-E (Peripheral Component Interconnect-Express) bus.

Please refer to FIG. 1, FIG. 2, and FIG. 3. These figures are a schematic diagram of conventional card readers 100, 200, and 300, respectively. The card reader 100 is implemented with a USB bus 102, the card reader 200 is implemented with a PCI bus 202, and the card reader 300 is implemented with a PCI-E bus 302. Briefly, the card readers 100, 200, and 300 utilize host controllers 104, 204, and 304, respectively, as bridges of data transferring and data converting between host computers (101, 201, and 301) and memory cards (e.g. SD cards 116, 216, and 316; MMC cards (Multimedia Card) 118, 218 and 318; MS cards (Memory Stick) 120, 220 and 320).

Hence, the performance regarding the host controllers 104, 204, and 304 has a deep influence on data transfer rate of the card reader 100, 200, and 300. However, designs of the host controllers actually depend on the speciation of the bus. For example, when considering theoretical bandwidths of said three buses, they respectively are: USB 480 Mbit/s (USB 2.0), PCI 133*8 Mbit/s, PCI-E 2.5 GT/s (x1 link).

Therefore, theoretical bandwidths represent limitations of data transfer rate of each card reader. Actual operational methods of these buses influence the practical performance of theoretical bandwidths. For instance, the multi-function card reader based on a USB bus is allowed to access only one data storage device at one time, so the practical bandwidths are decided by which device is coupled to the card reader. In addition, a USB bus can only provide a bandwidth of 480 bit/s while the fastest memory card has the maximum write/read speed of 250 Mbit/s. When considering latency of circuits, the bandwidth of the USB bus will not be able to catch up with the increasingly faster memory cards. Furthermore, the memory card reader based on a PCI bus or a PCI-E bus needs a host bus adapter to connect to the host computer system, which costs more money and causes complexity of hardware.

### SUMMARY OF THE INVENTION

It is therefore one objective of the present invention to provide a new scheme of the host controller disposed in a multi-function card reader. The host controller employs an interface based on a SATA bus for data transmission and can support up to 15 peripheral devices simultaneously. As a result, the problem of controllers based on the conventional scheme lacking high efficiency in data transmission is solved. A bandwidth of a SATA bus can even reach 3000 Mbit/s, which is a very high value in common PCs, thereby satisfying needs of transferring a huge amount of data.

A host controller disposed in a multi-function card reader is provided according to one exemplary embodiment of the present invention. The host controller comprises a Serial Advanced Technology Attachment (SATA) interface, for coupling to a host computer; and a port multiplier, having a control port and a plurality of peripheral device ports. The control port is coupled to the SATA interface, and the plurality of peripheral device ports are respectively coupled to a plurality of peripheral device interfaces. In addition, the plurality of peripheral device interfaces is disposed in the multi-function memory card reader. A main aim of the present invention is to expand the number of peripheral devices supported by a single multi-function card reader by means of a port multiplier (up to 15 peripheral devices). In addition, all peripheral devices coupling to the multi-function card reader can be accessed by the host computer at a same time by a high effective data transmission mode and multiplexing operations supported by the SATA bus, thereby fully approaching the maximum bandwidth of 3000 Mbit/s provided by the SATA bus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional card reader employing a USB interface.

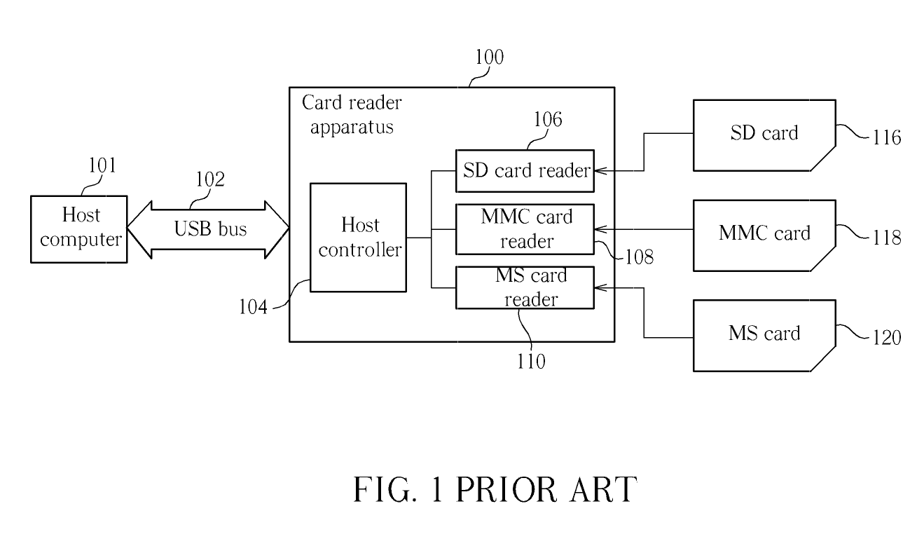

FIG. 2 is a diagram of a conventional card reader employing a PCI interface.

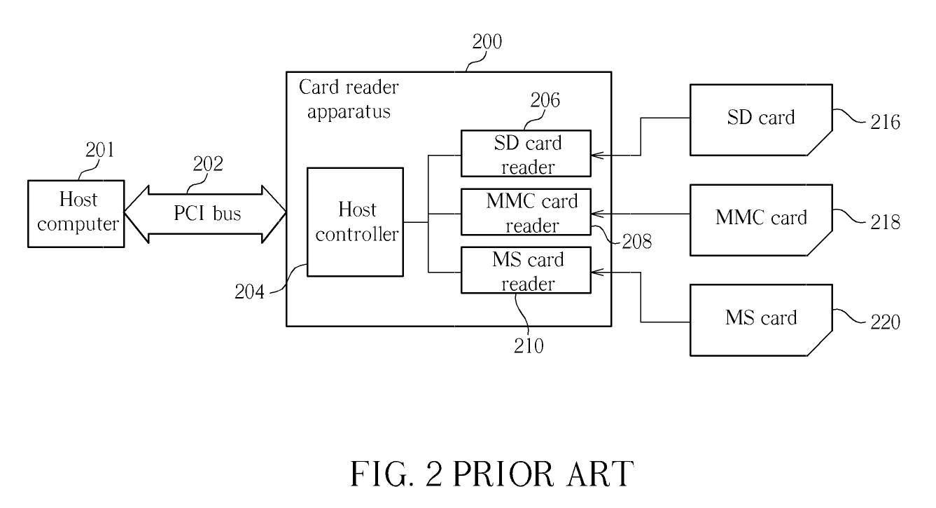

FIG. 3 is a diagram of a conventional card reader employing a PCI-E interface.

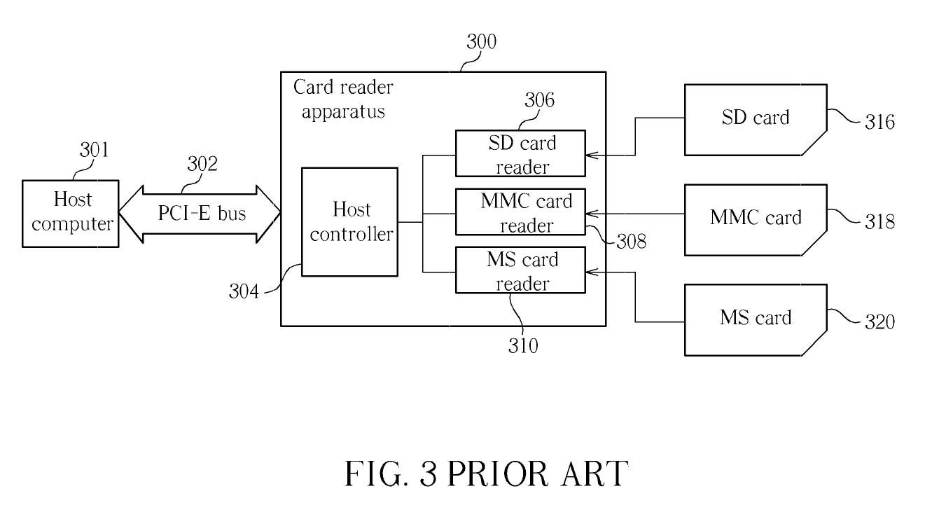

FIG. 4 is a diagram of the host controller of the present invention disposed in a multi-function card reader.

### DETAILED DESCRIPTION

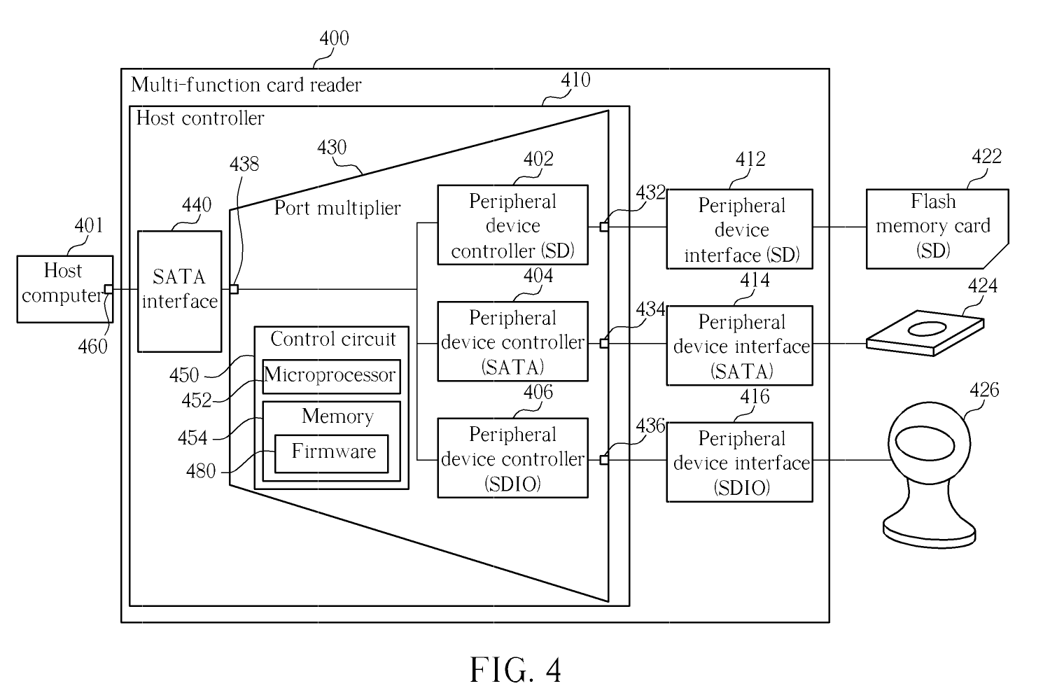

Please refer to FIG. 4, which illustrates a diagram of the controller disposed in a multi-function card reader according to one exemplary embodiment of the present invention. In this embodiment, a multi-function card reader 400 comprises a host controller 410 and a plurality of peripheral device interfaces 412, 414, and 416, wherein the peripheral interfaces 412, 414, 416 are respectively coupled to the device ports 432, 434, 436 of the host controller 410. Please note that there are only three peripheral device interfaces and three device ports in the diagram, but this is only for illustrative purpose and is not a limitation of the present invention. The peripheral device interface 412 is compatible with a Secure Digital Card (SD card) and is therefore for coupling to a flash memory card 422 of SD standard. The peripheral device interface 414 is compatible with a SATA device and is therefore for coupling a hard disk drive 424 having a SATA port. The peripheral device interface 416 is compatible with a SDIO (Secure Digital Input/Output) device and is therefore for coupling a video capture device 426 having a SDIO interface.

As shown in FIG. 4, the host controller 410 includes a port multiplier 430 and a SATA interface 440, wherein the port multiplier 430 includes a control port 438, peripheral device ports 432, 434, 436, peripheral device controllers 402, 404, 406 respectively coupled to the peripheral device ports 432, 434, 436, and a control circuit 450. The peripheral device controllers 402, 404, 406 are coupled to the control circuit 450 and further coupled to the SATA interface 440. Inside the port multiplier 430, the control circuit 450 is utilized for dispatching/processing commands and responses between the SATA interface 440 and the peripheral device controller 402, the peripheral device controller 404, and the peripheral device controller 406. The peripheral device controllers 402, 404, 406 respond to received commands, and control access to the peripheral devices coupling to the flash memory card 422, the hard disk drive 424, and the video capture device 426 in accordance with received commands. The port multiplier 430 supports a data transmission mode named frame information structure-based switching (FIS-based switching) in accordance with a SATA host controller (host computer side); with the FIS-based switching, when the host computer 401 is planning to proceed with data access to a device ready for I/O, data transmission can proceed directly regardless of whether the other peripheral device is operating in response to previously issued commands.

Thus, the port multiplier 430 will direct data to any drive ready for I/O. A specific arbitration algorithm ensures a balanced data flow with no latency in data transmission. The FIS-based switching employed by the port multiplier 430 allows devices to be accessed at a same time, thereby fully using the higher bandwidth of the 3000 MB/s host link. The FIS-based switching is formulated by the SATA specification and also well known to those skilled in the art, so detailed descriptions about the FIS-based switching are omitted here for the sake of brevity.

In this embodiment, the port multiplier 430 complying with the SATA specification can support up to 15 peripheral devices. The supporting types of peripheral devices depend on peripheral device controllers allocated inside the host controller. In the embodiment shown in FIG. 4, the peripheral device controllers 402, 404, 406 allocated in the host controller 410 are merely for illustrative purposes, not limitations of the present invention. For instance, the peripheral device controller 402 may also be compatible with an MMC card, a Memory Stick card, an xD-Picture card, or a Compact Flash card; the corresponding peripheral device interface 412 therefore complies with MMC standard, Memory Stick standard, xD-Picture standard, or Compact Flash standard, accordingly. Thus, the host controller can support any desired memory card by proper design. Furthermore, hardware allocation illustrated in the above embodiment is not the only case, and any hardware allocation conforming to the spirit of the present invention falls within the scope of the present invention.

After the multi-function memory card reader 400 is coupled to a SATA port 460 of the host computer 401 via the SATA interface 440, the host computer can proceed with data access to the flash memory card 422, a hard disk drive 424, and the video capture device 426 simultaneously. A microprocessor 452 in the control circuit 450 executes a firmware 480 stored inside the memory 454 to control data transaction between the peripheral devices 422, 424, 426 and the peripheral device controllers 402, 404, 406 according to commands issued by the host computer; that is, by sending commands to the peripheral device controllers 402, 404, 406, the peripheral device controller performs control over the peripheral devices 422, 424, 426 in accordance with the command, and writes/loads data in/from the peripheral devices 422, 424, 426.

For example, if the host computer 401 desires to use the video capture device 426, the host computer 401 will send a command, and the control circuit 450 then transmits signals to the peripheral device controller 406 according to the command sent by the host computer 400. Afterwards, the peripheral device controller 406 starts to control operations of data access regarding the video capture device 426 via the peripheral device interface 416. At this point, video or images captured by the video capture device 426 are sent back to the host controller 410, and the video/images data will be further sent back to the host computer 401 via the SATA interface 440. By the same means, when the host computer 401 desires to write data into the flash memory card 422, the host computer 401 issues a command via the SATA interface 440 to the host controller 410. After receiving the command, the control circuit 450 dispatches this command to the peripheral device controller 402 to understand the status of the flash memory card 422. If the flash memory card 422 is writable and idle, the peripheral device controller 402 directs data from the host computer 401 to the flash memory card 422 via the peripheral device interface 412. If the host computer 401 desires to load data from the hard disk drive 424, the process as mentioned above will be executed. The control circuit 450 and the peripheral device controller 404 take over processing of data access. Finally, data loaded from the hard disk drive 424 will be transmitted back to the host computer 401 via the SATA interface 440. Please note that the above-mentioned access to different devices can be performed at a same time in the FIS-based switching mode supported by the port multiplier 430.

To sum up, employing a SATA interface as the transmission interface of a card reader has the following advantages. First, motherboards in the commercial markets usually have built-in SATA ports, which also support hog-swapping. Thus, the convenience is the same as USB ports, however, the bandwidth and performance of the SATA bus are greater than those of the USB bus. Furthermore, compared to memory card readers based on a PCI bus or a PCI-E bus, the card reader via a SATA bus only uses a “port” (like a socket) rather than a host adapter (an electric circuit board) to couple to a host computer and the SATA bus also has a greater bandwidth than PCI, PCI-E and USB. Therefore, SATA is a best choice for both performance and convenience of hardware design.

A SATA bus is substantially for connecting to storage devices having SATA interfaces (e.g. hard disk drive or optical disk drive) and a single SATA port is only coupled to a single device by definition. The present invention employs a port multiplier formulated in the SATA specification to implement a host controller having capability of coupling to up to fifteen peripheral devices. Furthermore, allocating a variety of peripheral device controllers in the host controller allows the multi-function card reader to support extensive peripheral devices having different interfaces. For example, allocating an SD controller (peripheral device controller 402) inside the host controller means the host controller is able to support an SD card (e.g. flash memory card 422) while allocating an SDIO controller (peripheral device controller 406) inside the host controller means the host controller is able to support an SDIO device (e.g. video capture device 426), thereby expanding the uses of a single SATA port. Therefore, the capability of the SATA bus to couple to different devices is increased.

Those skilled in the art will readily observe that numerous modifications and alterations of the device and method may be made while retaining the teachings of the invention.

What is claimed is:

1. A host controller disposed in a multi-function card reader, comprising:
a Serial Advanced Technology Attachment (SATA) interface, configured for coupling to a host computer; and
a port multiplier having a control port and a plurality of peripheral device ports, wherein the control port is coupled to the SATA interface, and the peripheral device ports are coupled to a plurality of peripheral device interfaces, respectively, and the peripheral device interfaces are disposed in the multi-function card reader and comprise at least one flash memory card interface.

2. The host controller of the claim 1, wherein the port multiplier comprises:
a plurality of peripheral device controllers, coupled between the plurality of the peripheral device ports and the control port, respectively, configured for controlling the plurality of the peripheral devices; and
a control circuit, coupled to the plurality of the peripheral device controllers, configured for controlling operations of the plurality of the peripheral device controllers in order to control data transaction between the plurality of the peripheral device ports and the control port.

3. The host controller of the claim 2, wherein the control circuit comprises:
a memory, for storing a firmware; and
a microprocessor, coupled to the memory, for executing the firmware and controlling operations of the plurality of the peripheral device controllers.

4. The host controller of the claim 1, wherein the memory card interface is compatible to a Secure Digital Card (SD), a Multimedia Card (MMC), an xD-Picture Card (xD), or a Compact Flash card (CF).

5. The host controller of claim 1, wherein the plurality of the peripheral device interfaces further comprises a secure digital input/output (SDIO) interface.

6. The host controller of the claim 1, wherein the plurality of the peripheral device interfaces further comprises a SATA interface.
